(19) United States
(12) Patent Application Publication
(10) Pub. No.: US 2018/0025600 A1
(43) Pub. Date: Jan. 25, 2018

(54) INTERACTIVE SECURITY ALERT SYSTEM

(71) Applicant: H.P.B OPTOELECTRONIC CO., LTD, Taichung City (TW)

(72) Inventors: Hsuan-Yueh HSU, Taichung City (TW); Chun-Nan HSIAO, Taichung City (TW)

(21) Appl. No.: 15/652,903

(22) Filed: Jul. 18, 2017

(30) Foreign Application Priority Data
Jul. 19, 2016 (TW) 105122758
Jul. 19, 2016 (TW) 105122759

(51) Int. Cl. G08B 13/196; H04N 5/775; G06T 7/521

(52) U.S. Cl. CPC G08B 13/19691; G08B 13/19628; G08B 13/19636; G06T 7/521; G08B 13/19613; H04N 5/775; G06T 2207/30232; G06T 2207/30196; G06T 2207/10016; G06T 2207/10028

(57) ABSTRACT

A security alert system includes a light emitting unit, an image capturing unit, a distance arithmetic unit, a multimedia player unit and an alarm generating unit, wherein the image capturing unit and the distance arithmetic unit capture and calculate varied images of a viewer and an optical pattern emitted from the light emitting unit whether the viewer is within the range of an exhibition/performance activity such that the multimedia player unit displays a corresponding exhibition/performance activity to been seen or heard by the viewer, and if the viewer approaches near a boundary line of the display content, the alarm generating unit generates an alarm signal or sound to be seen or heard by the viewer and hence providing interactive effects between the exhibition/performance activity and the viewer.

### CROSS-REFERENCE TO RELATED APPLICATION

This application claims the priorities of Taiwanese patent application No. 105122758, filed on Jul. 19, 2016, and Taiwanese patent application No. 105122759, filed on Jul. 19, 2016, which are incorporated herewith by reference.

### BACKGROUND OF THE INVENTION

### 1. Field of the Invention

The present invention relates generally to an interactive security alert system, and more particularly to a security alert system that is adapted to be installed in an exhibition hall to exhibit an exhibition/performance activity to be seen by a viewer and that is adapted to generate an alert signal or sound in case the viewer trespasses on a boundary line of the display content.

### 2. The Prior Arts

An exhibition hall is a place, where different kinds of display activities or display contents are exhibited in different modes so as to seen or viewed by visiting audience or viewers. The display contents may include artworks, new electronic gadgets or products, industrial and commercial items, dynamic drama performances and singing performances. Of late, more and more people visit or take part in the exhibitions in order to promote or enhance their lives and/or knowledge. A conventional exhibition, like static artworks, industry or commerce displays, mostly includes written texts and image show with vocal explanation. Alternatively, live people are assigned directly to introduce the relevant content of the show to visitors, in order to achieve the purpose of interaction with the visitors.

In the event that when there is no visitors in the exhibition hall, the image display and vocal explanation processes are continuously repeated, thereby causing undesired extra expense and if live people are hired to conduct the introduction of the display items, the extra expense also increases. If the display items are of high values, security guards must be hired and assigned to remind the visitors not to trespass on the boundary line of the display contents. The security guards may fail to notice every corner of the exhibition hall and the visitors when the crowd is over crowded.

### SUMMARY OF THE INVENTION

A primary objective of the present invention is to provide an interactive security alert system, and more particularly to a security alert system that is adapted to be installed in an exhibition hall to exhibit an exhibition/performance activity to be seen by a viewer and that is adapted to generate an alert signal or sound in case the viewer trespasses on a boundary line of the display content. The security alert system of the present invention mainly utilizes an image capturing unit and a distance arithmetic unit to calculate a varied image of the viewer and/or variations of image of the viewer and an optical pattern emitted from a light emitting unit onto the viewer so as to determine a distance between the exhibition/performance activity and the viewer such that when the viewer is within the detection range, a multimedia player unit displays the corresponding show activities. In the event that the viewer has trespassed onto the boundary line of the display content, an alarm generating unit generates an alarm signal or sound to be effectively seen or heard by the viewer, thereby providing security to the display contents and hence economizing the labor waste and extra expenses.

An interactive security alert system of the present invention is adapted to be installed in an exhibition hall to exhibit an exhibition/performance activity to be seen by a viewer, includes: a light emitting unit, an image capturing unit, a distance arithmetic unit, a multimedia player unit and an alarm generating unit. The light emitting unit is adapted to install in the exhibition hall for emitting a light beam consisting of an optical pattern onto the viewer, wherein the optical pattern varies depending on a distance between the viewer and the display content. The image capturing unit is adapted to install in the exhibition hall corresponding to the light emitting unit, includes an optical lens for capturing images of the optical pattern and the viewer and a photosensitive element coupled with the optical lens for sensing the images. The distance arithmetic unit is adapted to install in the exhibition hall and is coupled electrically with the image capturing unit for receiving the images from the image capturing unit to calculate the distance between the viewer and the exhibition/performance activity based on variation of the images. The multimedia player unit is adapted to install in the exhibition hall and is coupled electrically with the distance arithmetic unit such that when the distance between the viewer and the exhibition/performance activity is smaller than a first threshold, the multimedia player unit displays multimedia information corresponding to the exhibition/performance activity to be seen by the viewer. The alarm generating unit is adapted to install in the exhibition hall and is coupled electrically with the multimedia player unit such that when the distance between the viewer and the exhibition/performance activity is smaller than a second threshold, the alarm generating unit generates an alarm signal or sound to be seen or heard by the viewer.

In the abovementioned security alert system of the present invention, the light emitting unit is selected from a group consisting of a laser device, an LED unit and an illuminator.

In the abovementioned security alert system of the present invention, the optical pattern is selected from a group consisting of a grid, a straight line, an irregularly arranged pattern and a regularly arranged pattern.

In the abovementioned security alert system of the present invention, the light beam emitted from the light emitting unit is a visible light beam or an invisible light beam.

In the abovementioned security alert system of the present invention, the optical lens is selected from a group consisting of a fish lens, a wide-angle lens and a standard lens.

In the abovementioned security alert system of the present invention, the photosensitive element is selected from a group consisting of a CCD (Charged-Couple Device) and a CMOS (Complementary Metal-Oxide-Semiconductor).

In the abovementioned security alert system of the present invention, the calculated distance between the viewer and the exhibition/performance activity is based on the variation of the images that consists of either variation of image of the viewer or variation of the optical pattern on the viewer or a combination of the former two variations.

In the abovementioned security alert system of the present invention, the multimedia information displayed by the multimedia player unit consists of a two-dimensional image, a three-dimensional image, a surrounding image, a photo, a text, a picture, an animation, or sound, or a combination of two or more.

In the abovementioned security alert system of the present invention, the alarm signal to be seen or heard by the viewer consists of a trumpet sound, a light beam, an image, a vibration or electrical signals, or a combination of two or more

In the abovementioned security alert system of the present invention, the light emitting unit is a flickering light source, which flicker frequency is the same as the frequency of the images captured by the image capturing unit, wherein the distance arithmetic unit further compares the image before and after the image capturing unit captures the image for determining variation of the optical pattern.

It is to note that because the security alert system of the present invention utilizes an image capturing unit and a distance arithmetic unit to calculate a varied image of the viewer and/or variations of image of the viewer and an optical pattern emitted from a light emitting unit onto the viewer so as to determine a distance between the exhibition/performance activity and the viewer such that when the viewer is within the detection range, a multimedia display unit displays the corresponding show activities. In the event that the viewer has trespassed onto the boundary line of the exhibition/performance activity, an alarm generating unit displays an alarm signal to be effectively seen or heard by the viewer, thereby providing security to the display contents and hence economizing the labor waste and extra expenses. In addition, the calculated distance between the viewer and the exhibition/performance activity is based on the variation of the images that consists of either variation of image of the viewer or variation of the optical pattern on the viewer or a combination of the former two variations such that when the distance between the viewer and the exhibition/performance activity is smaller than a first threshold, the multimedia player unit displays multimedia information corresponding to the exhibition/performance activity to be seen by the viewer and when the distance between the viewer and the exhibition/performance activity is smaller than a second threshold, the multimedia player unit displays an ala in signal to be seen or heard by the viewer, thereby providing security to the display contents and hence economizing the labor waste and extra expenses. The multimedia information displayed by the multimedia player unit may consist of a two-dimensional image, a three-dimensional image, a surrounding image, a photo, a text, a picture, an animation, or sound, or a combination of two or more. In the event that the viewer has trespassed onto the boundary line of the display content, the alarm generating unit displays or generates an alarm signal to be effectively seen or heard by the viewer, thereby preventing the viewer from approaching toward the display contents and economizing the expense for hiring of security guards.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a block diagram representing the elements constituting an interactive security alert system according to the present invention;

FIG. 2 is a perspective view of the interactive security alert system according to the present invention;

FIG. 3 is a perspective view illustrating how a multimedia player unit functions in the interactive security alert system according to the present invention; and

FIG. 4 is a perspective view illustrating how an alarm generating unit functions in the interactive security alert system according to the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

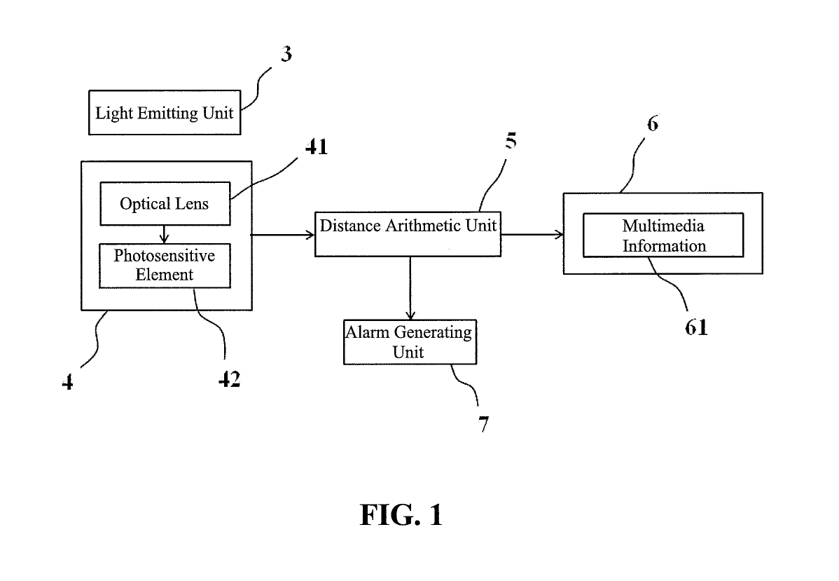

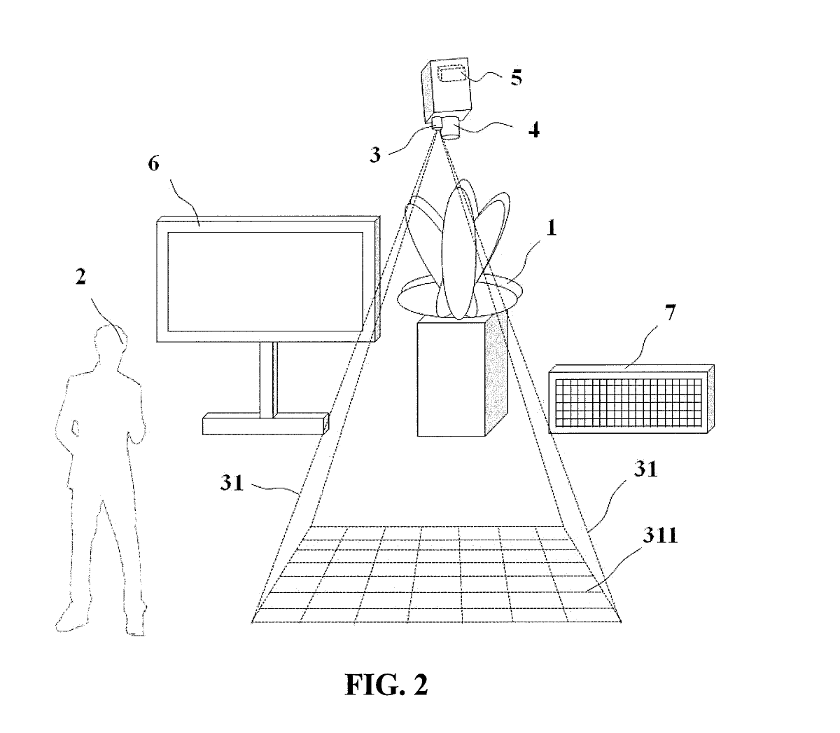

Referring to FIGS. 1 and 2, wherein FIG. 1 shows a block diagram representing the elements constituting an interactive security alert system according to the present invention; and FIG. 2 is a perspective view of the interactive security alert system according to the present invention. As shown, the interactive security alert system according to the present invention is adapted to be installed in an exhibition hall to exhibit a exhibition/performance activity 1 to be seen by a viewer 2, includes: a light emitting unit 3, an image capturing unit 4, a distance arithmetic unit 5, a multimedia player unit 6 and an alarm generating unit 7. Note that the exhibition/performance activity may be a static artwork, such as paintings of a well-known painter.

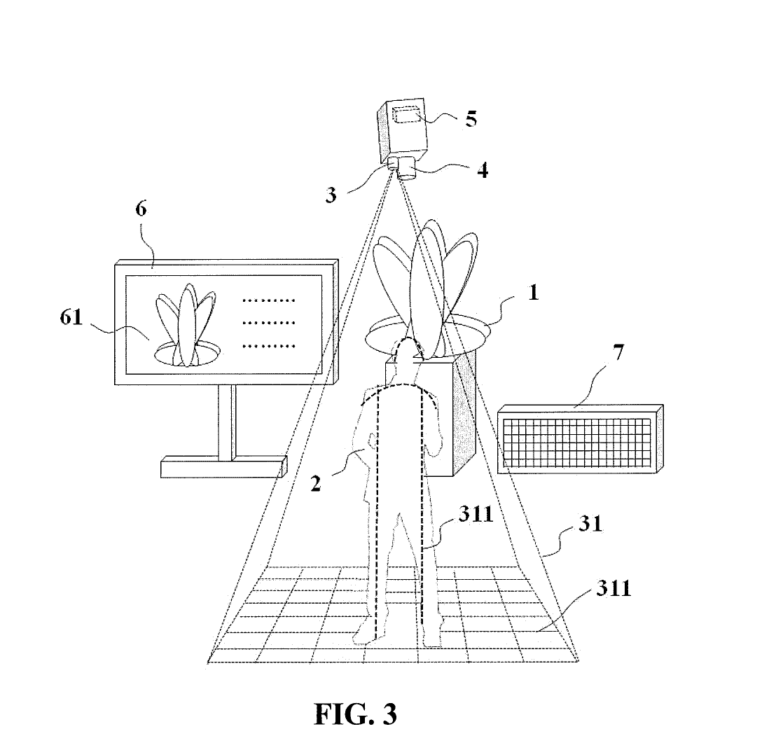

The light emitting unit 3 is adapted to install in the exhibition hall for emitting a light beam 31 consisting of an optical pattern 311 onto the viewer 2, wherein the optical pattern 311 varies depending on a distance between the viewer 2 and the exhibition/performance activity 1. Preferably, the light emitting unit 3 is selected from a group consisting of a laser device, an LED unit and an illuminator. The optical pattern 311 is selected from a group consisting of a grid, a straight line, an irregularly arranged pattern and a regularly arranged pattern. Referring to FIG. 3, the light beam 31 emitted from the light emitting unit 3 may be a visible light beam or an invisible light beam.

The image capturing unit 4 is adapted to install in the exhibition hall corresponding to the light emitting unit 3, includes an optical lens 41 for capturing images of the optical pattern 311 and the viewer 2 and a photosensitive element 42 coupled with the optical lens 41 for sensing the images. Preferably, the optical lens 41 is selected from a group consisting of a fish lens, a wide-angle lens and a standard lens. In addition, the photosensitive element 42 is selected from a group consisting of a CCD (Charged-Couple Device) and a CMOS (Complementary Metal-Oxide-Semiconductor).

The distance arithmetic unit 5 is adapted to install in the exhibition hall and is coupled electrically with the image capturing unit 4 for receiving the images from the image capturing unit 4, and calculates a distance between the viewer 2 and the exhibition/performance activity 1 based on variation of the images. Preferably, the calculated distance between the viewer 2 and the exhibition/performance activity 1 is based on the variation of the images that consists of either variation of image of the viewer 2 or variation of the optical pattern 311 on the viewer 2 or a combination of the former two variations.

The multimedia player unit 6 is adapted to install in the exhibition hall and is coupled electrically with the distance arithmetic unit 5 such that when the distance between the viewer 2 and the exhibition/performance activity 1 is smaller than a first threshold (value), the multimedia player unit 6 displays multimedia information corresponding to the exhibition/performance activity 1 to be seen by the viewer 2. Referring again to FIG. 3, the calculated distance between the viewer 2 and the exhibition/performance activity 1 is based on the variation of the images that consists of either variation of image of the viewer 2 or variation of the optical pattern 311 on the viewer 2 or a combination of the former two variations.

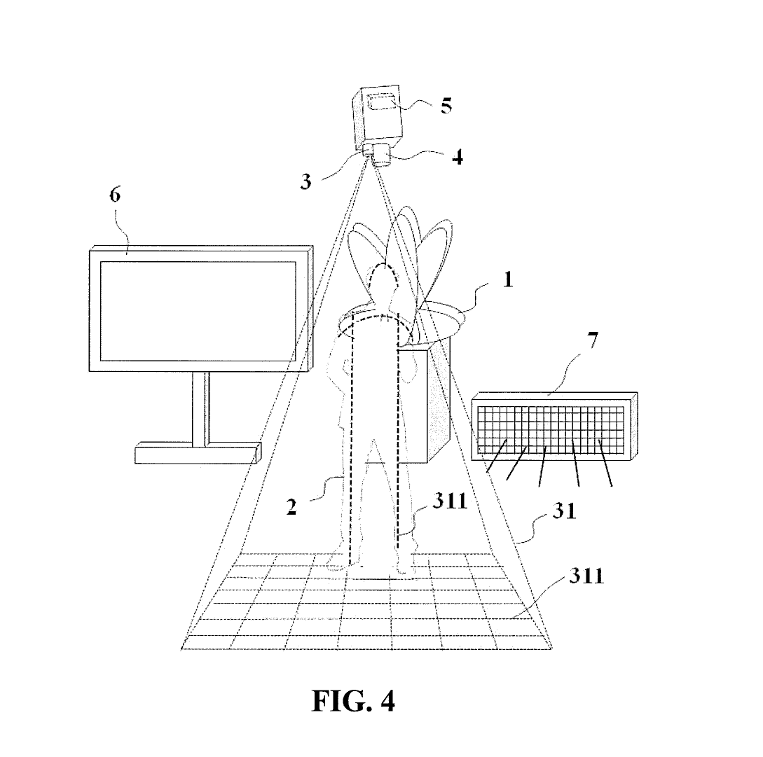

The alarm generating unit 7 is adapted to install in the exhibition hall and is coupled electrically with the multimedia player unit 6 such that when the distance between the viewer 2 and the exhibition/performance activity 1 is smaller than a second threshold (value), the alarm generating unit 7 generates an alarm signal to be seen or heard by the viewer 2. It is to note that the second threshold is smaller or shorter than the first threshold. Preferably, the alarm signal to be seen or heard by the viewer 2 may consist of a trumpet sound, a light beam, an image, a vibration or electrical signals, or a combination of two or more. FIG. 4 is a perspective view illustrating how an alarm generating unit 7 functions in the interactive security alert system according to the present invention. In the event that the viewer 2 has trespassed onto the boundary line of the exhibition/performance activity 1, the alarm generating unit 7 generates, upon sensing of the trespassing action, an alarm signal in the form of a buzzing sound via a speaker to be effectively seen or heard by the viewer 2, thereby reminding the viewer 2 not to approach too near to the exhibition/performance activity 1 or alternately informing the security guards if any to take care of this action, and hence providing security to the exhibition/performance activity 1 and/or economizing the labor waste and extra expenses. It is to note that the image capturing unit 4 consisting of an optical lens 41 is used herein to illustrate the better understanding of the security alert system of the present invention, the number and configuration of the light emitting unit 3, the image capturing unit 4 and the distance arithmetic unit 5, the multimedia player unit 6 and the alarm generating unit 7 should not be limited only to the disclosed ones.

Moreover, in one embodiment of the present invention, the light emitting unit 3 may be a flickering light source, which flicker frequency is the same as the frequency of the images captured by the image capturing unit 4. Preferably, the distance arithmetic unit 5 may further compare the two images captured by the image capturing unit 4 before and after for determining variation of the optical pattern 311. In another embodiment of the present invention, the light emitting unit 3 is a flickering light source exhibiting turned-on and turned-off states alternately, the frequency of which is the same as the frequency at which the image capturing unit 4 captures the images. It is to say that when the light emitting unit 3 emits a light beam 31 having the optical pattern 311 and is lit, the image capturing unit 4 captures the information between the viewer 2 and the optical pattern 311 and transmits to the distance arithmetic unit 5, and when the light emitting unit 3 of the next time is turned off, the image capturing unit 4 captures the image again and transmits it to the distance arithmetic unit 5, where the distance arithmetic unit 5 subtracts the images captured by before and after the time to perform the comparison action. Since the difference between the two images is only the presence or absence of the optical pattern 311, the two images can be subtracted separately so that the distance arithmetic unit 5 can more easily determine the variation of shapes the optical pattern 311 to determine whether the viewer 2 in front of the exhibition/performance activity 1 causes the variation or changes of the pattern 311.

One distinct feature of the present invention resides in that in the event a sponsoring organization wishes to exhibit an exhibition/performance activity 1 (such as static artwork) within an exhibition hall, the interactive security alert system of the present invention can be implemented in order to save manpower and the expense. Firstly of all, a light emitting unit 3 is installed at the exhibition/performance activity 1 of a static artwork, wherein the light emitting unit 3 emits a light beam 31 including at least one optical pattern 311, where the optical pattern 311 varies with the distance between the viewer 2 and the exhibition/performance activity 1. Secondly, an image capturing unit 4 is installed in the exhibition hall corresponding to the light emitting unit 3, wherein the image capturing unit 4 includes an optical lens 41, and a photosensitive element 42 coupled electrically to the optical lens 41, wherein the optical lens 41 captures the image of the viewer 2 and the optical pattern 311 on the photosensitive element 42. Thirdly, a distance arithmetic unit 5 is installed in the exhibition hall and is coupled electrically to the image capturing unit 4 such that the distance arithmetic unit 5 receives the image captured by the image capturing unit 4. The distance arithmetic unit 5 calculates the distance between the viewer 2 and the exhibition/performance activity 1. Fourthly, a plurality of multimedia player units 6 are installed in the exhibition hall and are coupled electrically with the distance arithmetic calculation unit 5 in such a manner that each of the multimedia player units 6 is arranged at each of the exhibition/performance activity 1, and when the distance between the viewer 2 and the exhibition/performance activity 1 calculated by the distance arithmetic unit 5 is less than a first threshold value, the multimedia player unit 6 displays the corresponding exhibition/performance activity 1 to the viewer 2 for enjoying the content. Finally, a plurality of alarm generating units 7 are installed in the exhibition hall in such a manner that each alarm generating unit 7 is coupled electrically with the distance arithmetic unit 5. Each alarm generating unit 7 is arranged corresponding to each of the exhibition/performance activity 1 in such a manner that the alarm generating unit 7 generates an alarm signal or sound when the distance between the viewer 2 and the exhibition/performance activity 1 calculated by the distance arithmetic unit 5 is less than a second threshold value. In the interactive security alert system of the present invention, the variation of the image of the viewer 2 is captured by the image capturing unit 4 and the distance arithmetic unit 5 calculates the optical pattern 311 transmitted by the light emitting unit 3 and the distance between the viewer 2 and the exhibition/performance activity 1 such that when the viewer 2 enters the detection range, where the multimedia player unit 6 plays out the corresponding exhibition/performance activity 1 (or within the optical pattern 311) to the viewer 2, and when the viewer 2 is further close to and touches the boundary line of the exhibition/performance activity 1, the alarm generating unit 7 generates an alarm signal or sound to warn or remind the viewer 2 not to trespass or cross the boundary line, thereby protecting the exhibition/performance activity 1. In other words, implementation of the security alert system of the present invention can save manpower and the expense by virtue of to interactive between the viewer 2 and the exhibition/performance activity 1.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A security alert system adapted to be installed in an exhibition hall to exhibit a display content, comprising:
a light emitting unit adapted to install in the exhibition hall for emitting a light beam consisting of an optical pattern onto a viewer, wherein said optical pattern varies depending on a distance between the viewer and the exhibition/performance activity;
an image capturing unit adapted to install in the exhibition hall corresponding to said light emitting unit, including an optical lens for capturing images of said optical pattern and the viewer and a photosensitive element coupled with said optical lens for sensing said images;
a distance arithmetic unit adapted to install in the exhibition hall and coupled electrically with said image capturing unit for receiving said images from said image capturing unit and calculating a distance between the viewer and the exhibition/performance activity based on variation of said images;
a multimedia player unit adapted to install in the exhibition hall and coupled electrically with said distance arithmetic unit such that when said distance between the viewer and the exhibition/performance activity is smaller than a first threshold, said multimedia player unit displays multimedia information corresponding to said exhibition/performance activity to be seen or heard by said viewer; and
an alarm generating unit adapted to install in the exhibition hall and coupled electrically with said multimedia player unit such that when said distance between the viewer and the exhibition/performance activity is smaller than a second threshold, said alarm generating unit generates an alarm signal to be seen or heard by said viewer, wherein said second threshold is smaller and/or shorter than said first threshold.

2. The security alert system according to claim 1, wherein said light emitting unit is selected from a group consisting of a laser device, an LED unit and an illuminator.

3. The security alert system according to claim 1, wherein said optical pattern is selected from a group consisting of a grid, a straight line, an irregularly arranged pattern and a regularly arranged pattern.

4. The security alert system according to claim 1, wherein said light beam emitted from said light emitting unit is a visible light beam or an invisible light beam.

5. The security alert system according to claim 1, wherein said optical lens is selected from a group consisting of a fish lens, a wide-angle lens and a standard lens.

6. The security alert system according to claim 1, wherein said photosensitive element is selected from a group consisting of a CCD (Charged-Couple Device) and a CMOS (Complementary Metal-Oxide-Semiconductor).

7. The security alert system according to claim 1, wherein said calculated distance between the viewer and the exhibition/performance activity is based on said variation of said images that consists of either variation of image of said viewer or variation of said optical pattern on said viewer or a combination of the former two variations.

8. The security alert system according to claim 1, wherein said multimedia information displayed by said multimedia player unit consists of a two-dimensional image, a three-dimensional image, a surrounding image, a photo, a text, a picture, an animation or sound, or a combination of two or more.

9. The security alert system according to claim 1, wherein said alarm signal to be seen or heard by said viewer consists of a trumpet sound, a light beam, an image, a vibration or electrical signals, or a combination of two or more

10. The security alert system according to claim 1, wherein said light emitting unit is a flickering light source, which flickering frequency is the same as the frequency of said images captured by said image capturing unit, wherein said distance arithmetic unit further compares the image before and after the image capturing unit captures the image for determining variation of said optical pattern.
